(19) United States
(12) Patent Application Publication
(10) Pub. No.: US 2017/0259622 A1
(43) Pub. Date: Sep. 14, 2017

(54) Tire With Improved Wet Grip In A Part-Worn State

(71) Applicants: COMPAGNIE GENERALE DES ETABLISSEMENTS MICHELIN, Clermont-Ferrand (FR); MICHELIN RECHERCHE ET TECHNIQUE S.A., Granges - Paccot (CH)

(72) Inventors: Vincent LEDIEU, Clermont-Ferrand Cedex 9 (FR); lllyes BATNINI, Clermont-Ferrand Cedex 9 (FR); Daniel FABING, Clermont-Ferrand Cedex 9 (FR); Jean-Charles DEROBERT-MAZURE, Clermont-Ferrand Cedex 9 (FR)

(73) Assignees: COMPAGNIE GENERALE DES ETABLISSEMENTS MICHELIN, Clermont-Ferrand (FR); MICHELIN RECHERCHE ET TECHNIQUE S.A., Granges-Paccot (CH)

(21) Appl. No.: 15/528,726

(22) PCT Filed: Nov. 20, 2015
(86) PCT No.: PCT/FR2015/053163

§ 371 Date: May 22, 2017

(30) Foreign Application Priority Data
Nov. 21, 2014 (FR) 1461292

(51) Int. Cl. B60C 11/03; B60C 11/13

(52) U.S. Cl. CPC B60C 11/0302; B60C 11/1307; B60C 2011/0344; B60C 2011/0358

(57) ABSTRACT

A tire comprising a tread comprising a plurality of main grooves (1) arranged on each side of a midplane X-X′, each of these main grooves (1) opening axially to the outside of the tread and extending axially towards the midplane X-X′ so that the plurality of main grooves forms a pattern in the overall shape of a V. Above and beyond a determined certain degree of wear, at least one additional groove (3) appears between two circumferentially adjacent main grooves (N−1, N), the additional groove running parallel overall to the main grooves (N−1, N).

The invention relates to the field of tires intended to be fitted to a passenger vehicle and that can be used in the winter. More specifically, the invention relates to a tire exhibiting improved performance, in a part-worn state, on wet ground.

The grip of a tire on the surface of a road is a critical element for allowing a driver of a vehicle to control his speed and his steering when driving. This grip becomes all the more critical in the winter on wet ground, where there comes into play a layer of water that the tire has to be able to remove otherwise the driver risks losing all control of his vehicle.

Document FR2291879 discloses a tire profile that makes it possible to improve the safety of such a vehicle driving on a wet road surface. This profile consists of a plurality of half-parabola-shaped grooves starting from the middle part of the tire tread and leading towards the two ends. Thus, water present on the road and entering the profile of the tire is delivered to the sides, making it possible to eliminate this layer of water and thereby improve the grip of the vehicle.

As long as the tread is in good condition, the removal of this layer of water is efficient. However, this efficiency decreases with tire wear and driving becomes dangerous above and beyond a certain degree of wear if the tire is not swiftly changed.

The objective of the invention is to provide a tire that has improved grip on wet ground when the tread of the said tire is worn.

This is what is meant in the description by the following:

The tread of a tire: a quantity of rubber material delimited by lateral surfaces and by two main surfaces one of which is intended to come into contact with the roadway when the tire is being driven on;
Circumferential direction: the direction that is tangential to any circle, for example to the circle formed by a tire, and centred on an axis of rotation;
Degree of wear of the tread: the ratio between a thickness that the tread has lost through wear and the total thickness that the tread can lose before having to be replaced. Thus, a degree of wear of 25% means that the tread has lost one quarter of the wearable rubbery material;
Surface void ratio of a tread: the amount of voids present on the tread surface of this tread. These voids are notably generated by the grooves of the tread.

The invention relates to a tire comprising a tread comprising a plurality of main grooves arranged on each side of a midplane X-X′, each of these main grooves opening axially to the outside of the said tread and extending axially towards the midplane X-X′ so that the plurality of main grooves forms a pattern in the overall shape of a V, characterized in that, above and beyond a determined certain degree of wear, at least one additional groove appears between two circumferentially adjacent main grooves, denoted (N−1, N), the said additional groove running parallel overall to the said main grooves (N−1, N).

Thus, according to the invention, at least one additional groove is provided between each pair of circumferentially adjacent main grooves (N−1, N) such that it appears above and beyond a certain degree of wear. The said additional groove contributes to the removal of the water lying between the tread of the tire and the road surface. Thus, this additional groove compensates at least in part for the loss of water removal efficiency suffered by the main grooves (N−1, N) as a result of the tire tread wear. This compensation therefore makes it possible to maintain a good removal of the water and therefore good grip of the tire on wet ground despite the wear state of the said tire.

According to one embodiment, above and beyond the determined degree of wear, at least one intermediate groove appears between the two adjacent main grooves (N−1, N), and in that, with the pattern of the main grooves pointing in a direction R, corresponding to a preferred direction of rotation, the intermediate groove extends from one of the main grooves in this direction R, intersecting the additional groove, so as to form a network of grooves. This network of grooves, made up of an intermediate groove and of an additional groove, makes it possible to improve the removal of water from the tread when the tire is being driven on.

According to one embodiment of the invention, the said intermediate groove opens into each of the adjacent main grooves (N−1, N).

According to another embodiment, the network of grooves is delimited in part by at least one bridge of rubber. This bridge of rubber allows the dimensions of the network of grooves to be adapted easily to the desired water-removal capacity. Specifically, the number and the position of the bridges of rubber are adapted according to the desired water-removal capacity.

Advantageously, the bridge of rubber comprises an inclined wall inclined towards the inside of the network of grooves. Such an inclination encourages the water to flow inside the network of grooves. What is meant by inside the network of grooves is the volume formed by an intermediate groove and by an additional groove of one same network. In the presence of such an inclined wall, water arriving at the additional groove is accelerated as it descends the said inclined wall. This acceleration allows for rapid removal of this water, through the intermediate groove, towards the main groove into which it opens.

According to one particular application, the inclined wall comprises a sipe extending along the inclination of this inclined wall. The addition of such a sipe allows the tread to be given greater flexibility in the region of the bridge of rubber. With this flexibility, the flattening of the tread is improved and, as a result, so too is the overall operation of the tire.

According to an alternative form, the network of grooves, having an upstream end and a downstream end opening into the main groove N, has a cross section that increases from upstream to downstream. This configuration makes it possible to improve the water removal still further because, since the water moving forward from upstream to downstream finds more free volume available, it is therefore removed with greater ease.

According to another embodiment, several networks of grooves open into one same main groove. This allows more water to be removed towards the main grooves.

Advantageously, the tread comprises a circumferential groove that is central overall, the main grooves and the additional grooves not opening into this circumferential groove. This circumferential groove makes it possible to improve removal of water on wet ground while driving. The fact that the main and secondary grooves do not open into this circumferential groove has the advantage of avoiding disturbing the flow of water inside the said circumferential groove.

According to one particular embodiment, all or some of the main grooves are connected respectively to the circumferential groove by a sipe. Such a sipe creates edge corners on the surface of the tread and this improves the grip on wet ground.

According to another embodiment, at the determined degree of wear, the tread has a surface void ratio greater than or equal to 35%. Such a void ratio is important for improving the removal of water still further.

According to one particular application, the determined degree of wear above and beyond which the additional groove or grooves appears (appear) is greater than 20%.

Further features and advantages will become more clearly apparent from reading the following description with reference to the attached drawings in which:

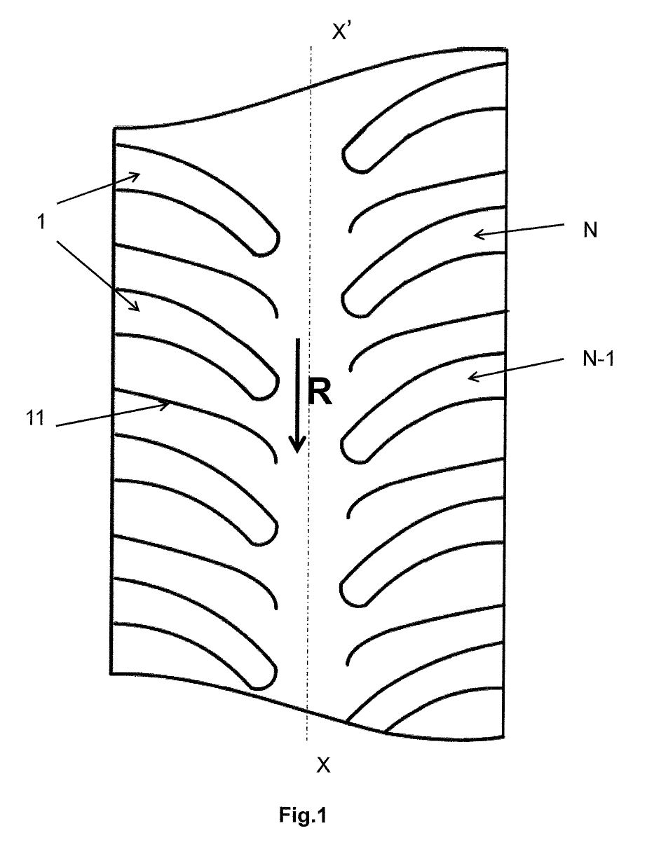

FIG. 1 is a view of a tire according to the invention, in the new condition;

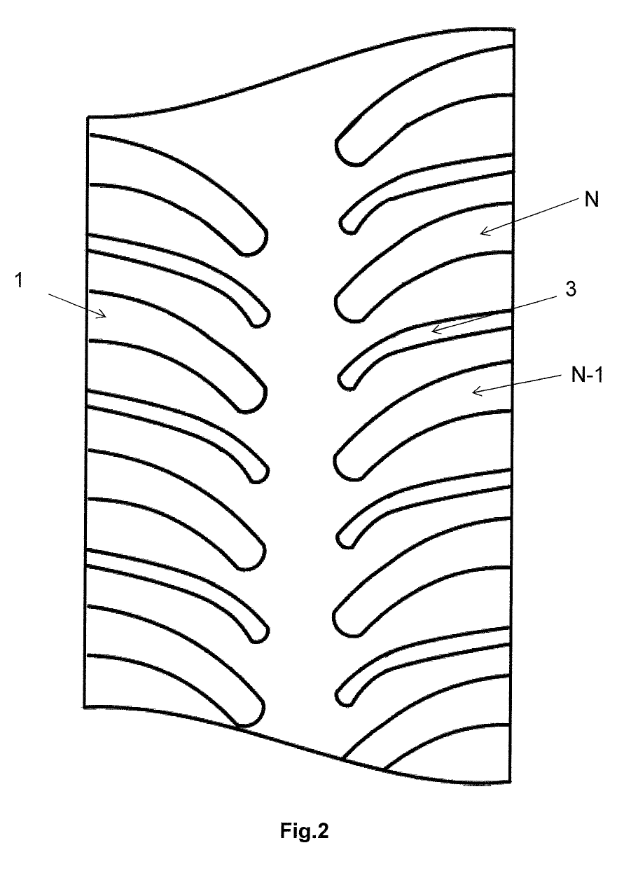

FIG. 2 is a view of a tire according to the invention, at a certain level of wear;

FIG. 3 is a view of a tire according to a second embodiment, at a certain level of wear;

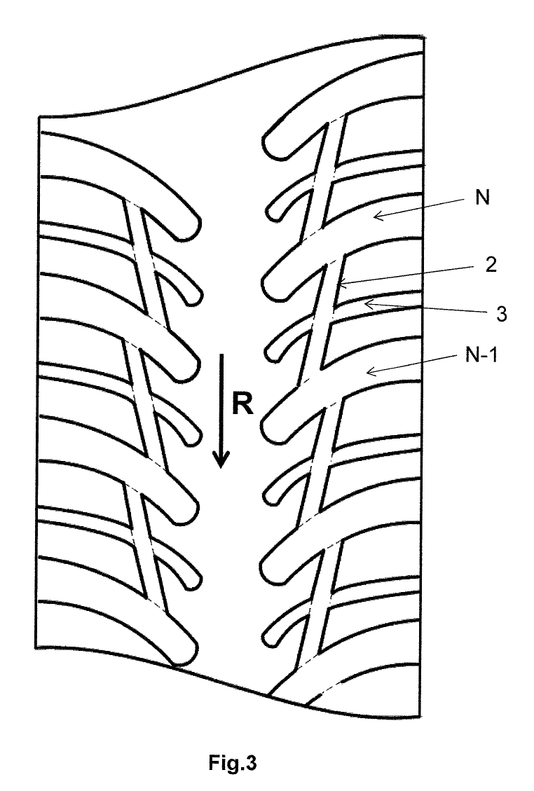

FIG. 4 is a view of a tire according to a third embodiment in which a bridge of rubber partially delimits the network of grooves;

FIG. 5 is a view of a bridge of rubber having an inclined wall;

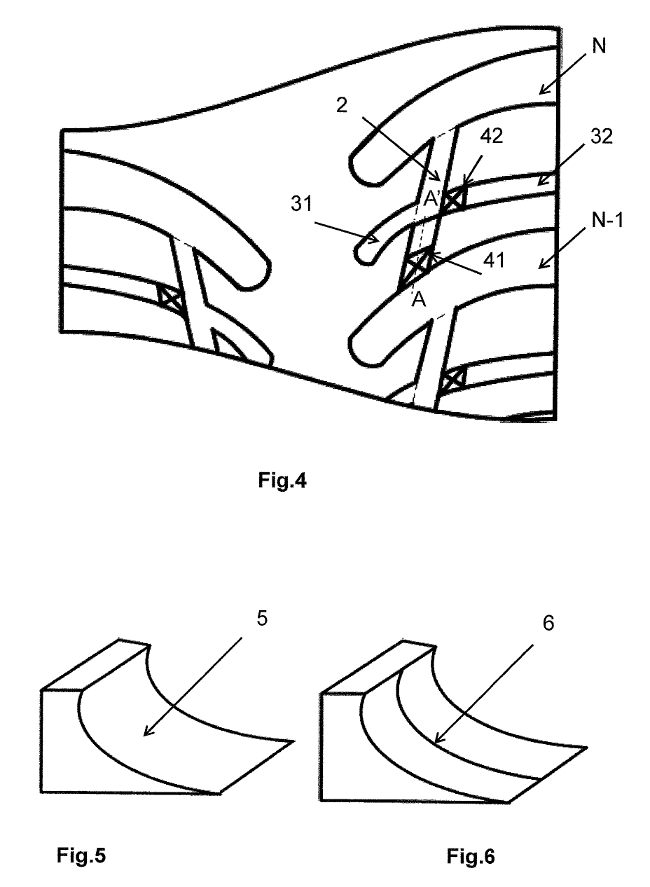

FIG. 6 is a view of a bridge of rubber having an inclined wall and comprising a sipe;

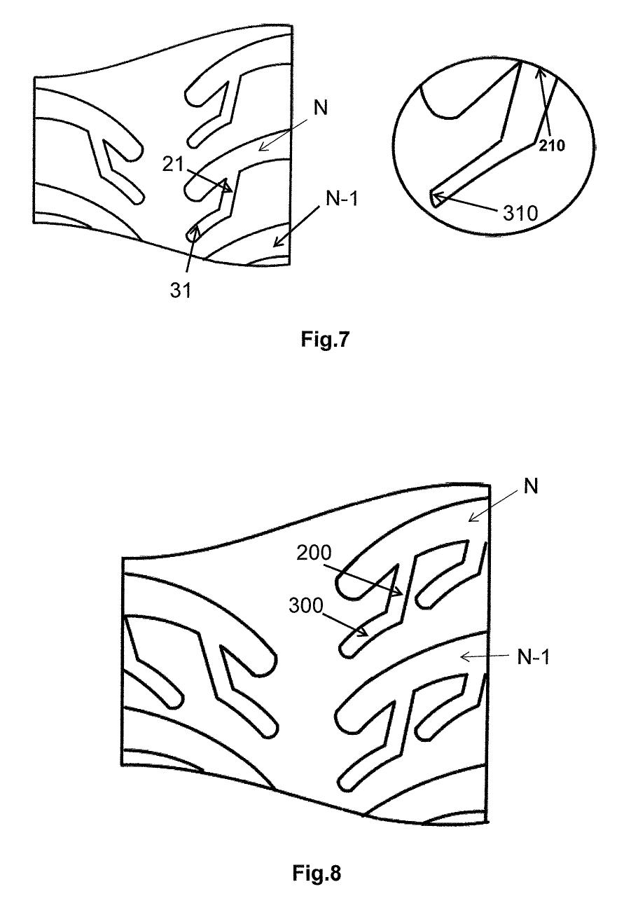

FIG. 7 is a view of a network of grooves according to a third particular embodiment;

FIG. 8 is a view of an embodiment in which several networks of grooves open into one main groove;

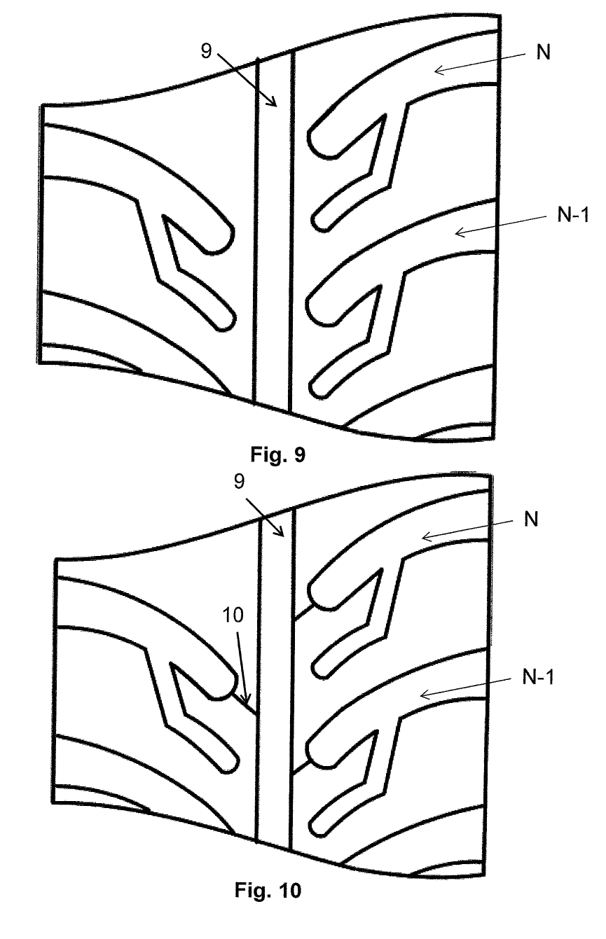

FIG. 9 is a view of a tread according to the invention, comprising a central circumferential groove;

FIG. 10 is a view of a tread according to the invention, comprising a central circumferential groove in which all or some of the main grooves are connected to this central groove by a sipe.

FIG. 1 schematically depicts a tread of a tire according to the invention in the new condition.

This tread comes into contact with the roadway during driving. It comprises a plurality of main grooves 1 arranged on each side of a midplane X-X′ and with there being N of them on each side. Each of these main grooves 1 opens axially, the axis being defined in the direction parallel to the axis of rotation of the tire, to the outside of this tread. This allows the water to be removed towards the exterior sides of the tire when the vehicle is driving, which means to say starting from the end of the groove nearest to the axis X-X′ towards the end of the groove furthest from the axis X-X′. Each of these main grooves is extended axially towards the midplane X-X′ such that the plurality of main grooves forms a pattern in the overall shape of a V. The point of this V indicates the preferred direction of rotation of this tread. This direction of rotation is also indicated by the arrow R.

Optionally, this tread may, in the new condition, comprise at least one sipe 11 between each two main grooves adjacent in the circumferential direction, which are denoted N−1 and N. Such a sipe makes it possible to improve grip on wet ground. It may have various shapes, for example elongate parallel to the main grooves N−1, N, as shown in FIG. 1. In such a configuration, it may notably be situated equidistant from the main grooves N−1, N. That makes it possible to equalize the forces between the two portions of tread, situated between the said sipe and the main groove N−1, and between the said sipe and the main groove N.

FIG. 2 shows a view of a tread according to the invention, in a certain state of wear. The tread looks like this when a determined certain degree of wear is reached. In this case, at least one additional groove 3 appears between two circumferentially adjacent main grooves N−1, N. This additional groove runs parallel overall to these two main grooves N−1, N. Such a groove has the advantage of compensating for the loss of water-removal efficiency caused to the main grooves by the wearing of the tread of the tire. This additional groove thus contributes to the removal of water in the same way as the main grooves by driving the water from the middle of the tread towards the exterior sides of the tread.

In one particular application, the determined degree of wear above and beyond which the additional groove or grooves appears (appear) is greater than 20%.

In order to optimize the water removal still further, the appearance of this additional groove, at this determined degree of wear, may be added to a condition regarding the surface void ratio of the tread. This void ratio is preferably greater than or equal to 35%.

In another embodiment illustrated in FIG. 3, when the determined degree of wear is reached, at least one intermediate groove 2 appears between the two adjacent main grooves N−1, N. This intermediate groove 2 extends from one main groove N in the direction R towards the adjacent main groove N−1, intersecting the additional groove 3. Thus, a network of grooves 2, 3 is formed by the intermediate groove 2 and the additional groove 3.

In this case, the removal of the water picked up by the additional groove 3 takes place at least in part towards the intermediate groove 2 which then removes it towards the main grooves N−1, N.

In the embodiment illustrated in FIG. 4, at least one bridge of rubber 4 partially delimits the network of grooves 2, 3. This delimitation is used to adapt the network of grooves to suit the desired water-removal capacity. A bridge of rubber 41 may, for example, separate the intermediate groove 2 from the main groove N−1. Another bridge of rubber 42 may, for example, divide the additional groove 3 into two parts 31 and 32. The part 31 opening into the additional groove 2 and the part 32 opening directly onto the side the outside of the tread.

One particularly preferred shape for such a bridge of rubber 4 is illustrated in FIG. 5 which depicts a section on AA′ of FIG. 4. In this embodiment, the bridge of rubber 4 has an inclined wall 5 inclined towards the inside of the network of grooves 2, 3. Thus, the height of the bridge of rubber decreases from the outside towards the inside of the volume formed by the groove 2 and the groove 3. One advantage of such an embodiment is that of encouraging water to circulate in the network of grooves. Specifically, the water descending this wall is accelerated because of the inclination thereof. Thus, the water descending the wall of the bridge of rubber 41 arrives at the intermediate groove 2 at a certain speed to then continue on to meet the main groove N. Likewise, the water descending the bridge of rubber 42 arrives at a certain speed at the part 32 and is thus removed quickly towards the exterior side of the tread.

According to a second shape illustrated in FIG. 6, the inclined wall 5 of the bridge of rubber 4 comprises a sipe 6 which extends along the inclination of this inclined wall 5. The benefit of such a sipe lies in the fact that it gives the tread greater flexibility in the region of the bridge of rubber. Thus, when the vehicle is driving along, the flattening of the tread is improved and, as a result, so too is the overall operation of the tire.

FIG. 7 depicts an alternative form of embodiment in which the network of grooves 21, 31 has a cross section that increases from its upstream end 310 towards its downstream end 210 opening into the main groove N. The benefit of this design lies in the fact that the water advancing from upstream to downstream finds more free volume available and is therefore removed with greater ease.

FIG. 8 shows another embodiment in which the tread of the tire comprises several networks of grooves 200, 300 which open into one same main groove 1. In this instance, the water collected by the additional grooves 300 is directed predominantly towards a main groove N.

FIG. 9 depicts yet another embodiment in which the tread comprises a circumferential groove 9 that is central overall. Such a groove contributes to the removal of the water while the vehicle is driving along. Furthermore, the main grooves 1 and the additional grooves 3 do not open into this circumferential groove 9. This has the notable advantage of not disturbing the flow of water inside the said circumferential groove.

According to an alternative form, some or all of the main grooves 1 are connected to this circumferential groove 9 by a sipe 10, as illustrated in FIG. 10. Such a sipe creates edge corners on the surface of the tread thereby improving grip on wet ground.

In another alternative form, the intermediate grooves (2) are present on the tire when the tire is in the new condition.

The invention is obviously not restricted to the embodiments set forth. It is possible to provide various modifications without thereby departing from the scope of the invention.

1. A tire comprising a tread comprising a plurality of main grooves arranged on each side of a midplane X-X′, each of said main grooves opening axially to the outside of said tread and extending axially towards the midplane X-X′ so that the plurality of main grooves forms a pattern in the overall shape of a V, wherein, above and beyond a determined certain degree of wear, at least one additional groove appears between two circumferentially adjacent main grooves, said additional groove running parallel overall to said main grooves, wherein at least one intermediate groove appears between said two adjacent main grooves, and wherein, with the pattern of the main grooves pointing in a direction R, the intermediate groove extends from one of the main grooves in this direction R, intersecting the additional groove, so as to form a network of grooves.

2. The tire according to claim 1, wherein the intermediate groove opens into each of the adjacent main grooves.

3. The tire according to claim 1, wherein the network of grooves is delimited in part by at least one bridge of rubber.

4. The tire according to claim 3, wherein the bridge of rubber comprises an inclined wall inclined towards the inside of the network of grooves.

5. The tire according to claim 4, wherein the inclined wall comprises a sipe extending along the inclination of this inclined wall.

6. The tire according to claim 3, wherein the network of grooves, having an upstream end and a downstream end opening into the main groove N, has a cross section that increases from upstream to downstream.

7. The tire according to claim 2, wherein several networks open into one same main groove.

8. The tire according to claim 1, wherein the tread comprises a circumferential groove that is central overall, the main grooves and the additional grooves not opening into this circumferential groove.

9. The tire according to claim 8, wherein all or some of the main grooves are connected respectively to the circumferential groove by a sipe.

10. The tire according to claim 1, wherein, at the determined degree of wear, the tread has a surface void ratio greater than or equal to 35%.

11. The tire according to claim 1, wherein the determined degree of wear above and beyond which the additional groove or grooves appears (appear) is greater than 20%.
